(19) United States
(12) Patent Application Publication
(10) Pub. No.: US 2009/0241720 A1
(43) Pub. Date: Oct. 1, 2009

(54) SHIFT LEVER ASSEMBLY FOR TRANSMISSION IN VEHICLE

(75) Inventor: Myung Hoe Kim, Seoul (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Kia Motors Corporation, Seoul (KR)

(21) Appl. No.: 12/193,434

(22) Filed: Aug. 18, 2008

(30) Foreign Application Priority Data
Mar. 31, 2008 (KR) 10-2008-0029899

(51) Int. Cl. G05G 1/04

(52) U.S. Cl. 74/491

(57) ABSTRACT

A bootless type shift lever assembly for a transmission in a vehicle, in which a separate gap blocking device is mounted so as to block a gap between the outer surface of a hard cover and an end of the open upper surface of a console, thereby preventing foreign materials from being introduced into the console toward a shift lever and a shift mechanism, more uniformly maintaining a motion path of the hard cover when the shift lever is manipulated to thereby allow the shift lever to be smoothly manipulated, preventing noise from being caused by the gap, and improving beauty of the interior of the vehicle.

### CLAIM OF PRIORITY

This application claims the benefit of Korean Patent Application No. 10-2008-0029899 filed on Mar. 31, 2008, in the Korean Intellectual Property Office, the disclosure of which is incorporated herein by reference.

### BACKGROUND OF THE INVENTION

1. Field of the Invention

The present invention relates to a shift lever assembly for a transmission in a vehicle and, more particularly, to a bootless type shift lever assembly for a transmission in a vehicle, in which a separate gap blocking device is mounted so as to block a gap between the outer surface of a hard cover and an end of the open upper surface of a console, thereby preventing foreign materials from being introduced into the console toward a shift lever and a shift mechanism, more uniformly maintaining a motion path of the hard cover when the shift lever is manipulated to thereby allow the shift lever to be smoothly manipulated, preventing noise from being caused by the gap, and improving beauty of the interior of the vehicle.

2. Description of the Related Art

Generally, automotive transmissions function to change driving torque generated from the engine so as to be suitable for running conditions during running, and to then transmit it to drive wheels, and are classified into a manual transmission, an automatic transmission, a continuously variable transmission, etc. according to an operation mode.

As for the manual transmission, a shift lever is manipulated to apply tension to shift and select cables, and thus a shifter mechanism installed on the side of the transmission is operated. Thereby, the geared power is transmitted through a gear train selected from a plurality of gear trains mounted in the transmission.

A shift lever assembly of this manual transmission is an apparatus that transmits manipulating force of the shift lever to the transmission so as to change the gears, and allows select manipulation in which the shift lever is manipulated left and right in order to select a gear position and shift manipulation in which the shift lever is manipulated back and forth toward the selected gear position.

FIG. 1 is a schematic perspective view illustrating the configuration of a conventional shift lever assembly for a manual transmission.

As illustrated in FIG. 1, the conventional shift lever assembly for the manual transmission has a shift lever 10 mounted in the interior of a vehicle so as to be able to be manipulated by a driver. The shift lever 10 is coupled to a shifter mechanism (not shown) at a lower end thereof such that a manipulating force thereof can be transmitted to the transmission (not shown). At this time, the shifter mechanism is located in a console 20 of the vehicle for beauty and safety of the interior of the vehicle as illustrated in FIG. 1. A boot 30 made of soft material such as leather or rubber is attached to an upper surface of the console 20 so as to enclose the shift lever 10. The boot 30 coupled in this way protects the shift lever 10 and the shifter mechanism, both of which are mounted in the console 20, for instance, prevents foreign materials from entering from the outside.

FIG. 2 is a schematic perspective view illustrating the configuration of another conventional shift lever assembly for an ordinary manual or semi-automatic transmission, FIG. 3 is a cross-sectional view taken along the line A-A of FIG. 2.

The boot-type shift lever assembly illustrated in FIG. 1 has a big-sized, corrugated shape, and thus reduces the beauty of the interior of the vehicle, and furthermore has a problem in that the boot 30 is torn off in use. The recent trend shows that, as illustrated in FIG. 2, a bootless type shift lever assembly, on which a hard cover 40 made of hard material such as plastic is mounted, has been developed to replace the boot 30.

In detail, as illustrated in FIGS. 2 and 3, the shift lever 10 is coupled to a shifter mechanism 50 at a lower end thereof The shifter mechanism 50 is located inside a console 20. The shift lever 10 is coupled with the hard cover 40 having a hollow semi-spherical shape of a predetermined curvature. At this time, the shift lever 10 passes through the center of the hard cover 40. In this manner, the hard cover 40 coupled to the shift lever 10 is configured to cover an open upper surface of the console 20, and to protect the shift lever 10 and the shifter mechanism 50. Thus, the beauty of the interior of the vehicle is improved, and the damage such as tear-off occurring in use is prevented.

However, as illustrated in FIG. 3, the bootless type shift lever assembly has a gap X between the outer surface of the hard cover 40 coupled to the shift lever 10 and the open upper surface of the console 20 for the purpose of providing anti-friction, assembly tolerance, etc. in view of its assembly structure. The foreign materials are introduced into the console 20 through this gap X, thereby causing the shift lever 10 and the shifter mechanism 50 to get out of order. Further, the beauty of the interior of the vehicle is reduced due to the gap X, for instance, the interior of the console 20 is viewed through the gap X from the outside. In addition, when manipulated, the shift lever 10 not only makes it impossible to conduct uniform constant manipulation due to the gap X but also causes noise.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

Embodiments of the present invention have been made to solve the foregoing problems with the prior art, and therefore the present invention is directed to a shift lever assembly for a transmission in a vehicle, in which a separate gap blocking device is mounted so as to block a gap between the outer surface of a hard cover and an end of the open upper surface of a console, thereby preventing foreign materials from being introduced into the console toward a shift lever and a shift mechanism, more uniformly maintaining a motion path of the hard cover when the shift lever is manipulated to thereby allow the shift lever to be smoothly manipulated, preventing noise from being caused by the gap, and improving beauty of the interior of the vehicle.

According to an aspect of the invention, there is provided a shift lever assembly for a transmission in a vehicle, which includes: a shift lever; a shifter mechanism, which is coupled with a lower end of the shift lever and transmits a manipulating force of the shift lever to the transmission; a hard cover disposed under a console and covering the open upper surface of a console in a hollow semi-spherical shape, wherein the hard cover is coupled to the shift lever passing through a hollow part of the console and the hard cover; and gap blocking device for blocking a gap between an end of the open upper surface of the console and an outer surface of the hard cover. Here, the gap blocking device is mounted on the end of the open upper surface of the console.

According to the present invention, the separate gap blocking device is mounted so as to block the gap between the outer surface of the hard cover and the end of the open upper surface of the console, thereby preventing foreign materials from being introduced into the console toward the shift lever and the shift mechanism, more uniformly maintaining the motion path of the hard cover when the shift lever is manipulated to thereby allow the shift lever to be smoothly manipulated, preventing noise from being caused by the gap, and improving beauty of the interior of the vehicle.

### BRIEF DESCRIPTION OF THE DRAWINGS

The above and other objects, features and other advantages of the present invention will be more clearly understood from the following detailed description taken in conjunction with the accompanying drawings, in which;

FIG. 1 is a schematic perspective view illustrating the configuration of a conventional shift lever assembly for a manual transmission;

FIG. 2 is a schematic perspective view illustrating the configuration of another conventional shift lever assembly for an ordinary manual or semi-automatic transmission;

FIG. 3 is a cross-sectional view taken along the line A-A of FIG. 2.

FIG. 4 is a cross-sectional view taken along the line A-A of FIG. 2 according to an embodiment of the present invention;

FIG. 5 is an enlarged cross-sectional view illustrating part “B” of FIG. 4; and

FIGS. 6 and 7 are enlarged cross-sectional views illustrating part “B” of FIG. 4 according to another embodiment of the present invention.

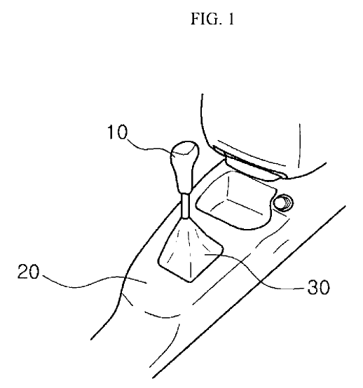

### DETAILED DESCRIPTION OF THE EXEMPLARY EMBODIMENT

The present invention will now be described more fully hereinafter with reference to the accompanying drawings, in which exemplary embodiments thereof are shown. Reference now should be made to the drawings, in which the same reference numerals and signs are used throughout the different drawings to designate the same or similar components. In the following description of the present invention, a detailed description of known functions and components incorporated herein will be omitted when it may make the subject matter of the present invention rather unclear.

The present invention is directed to a shift lever assembly for a transmission in a vehicle, which includes a shift lever 10, a shifter mechanism 50, which is coupled with a lower end of the shift lever 10 and transmits a manipulating force of the shift lever 10 to the transmission, a hard cover 40, which is disposed under a console 20 and configured to cover the open upper surface of the console 20 in a hollow semi-spherical shape, and is coupled to the shift lever 10 passing therethrough, and gap blocking device for blocking a gap between an end of the open upper surface of the console 20 and an outer surface of the hard cover 40. Here, the gap blocking device is mounted on the end of the open upper surface of the console 20.

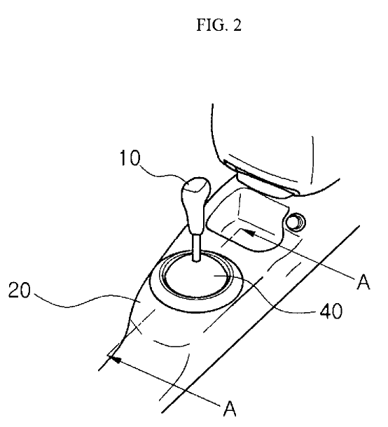

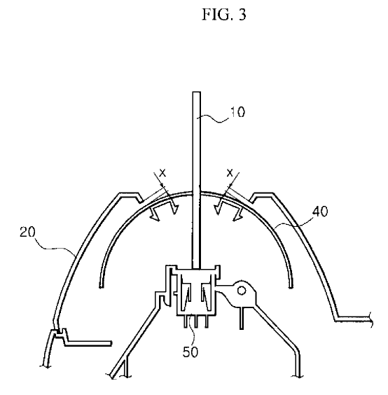

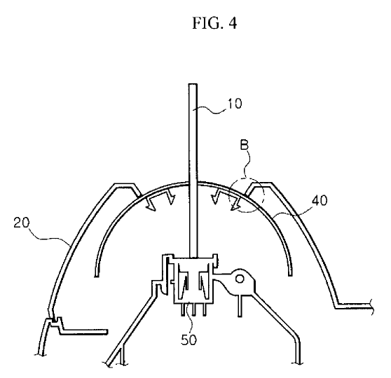

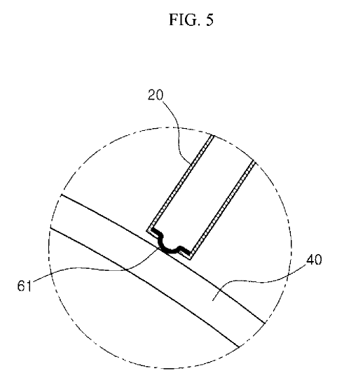

FIG. 4 is a cross-sectional view taken along the line A-A of FIG. 2 according to an embodiment of the present invention, and FIG. 5 is an enlarged cross-sectional view illustrating part “B” of FIG. 4.

A shift lever assembly for a transmission in a vehicle according to an exemplary embodiment of the present invention is directed to a bootless type shift lever assembly, which can be applied to a manual transmission and a semi-automatic transmission and is equipped with a hard cover 40 instead of a soft boot.

Thus, the shift lever assembly for a transmission in a vehicle according to an embodiment of the present invention includes a shift lever 10, which is manipulated by a driver, a shifter mechanism 50, which allows a manipulating force of the shift lever 10 to be transmitted to the transmission (not shown), and a hard cover 40, which has a hollow semi-spherical shape of a predetermined curvature and is coupled to the shift lever 10, as described above with reference to FIG. 2. At this time, the shifter mechanism 50 is coupled to a lower end of the shift lever 10, and is mounted in a console 20 of the interior of the vehicle. The hard cover 40 is coupled to the shifter lever 10, which passes through the hard cover, thereby covering an open upper surface of the console 20.

In addition to this configuration, the shift lever assembly according to the present invention further includes a gap blocking device, which is mounted on an end of the open upper surface of the console 20 so as to prevent a gap from being defined between the end of the open upper surface of the console 20 and the outer surface of the hard cover 40.

More specifically, as described above, the bootless type shift lever assembly, to which the hard cover 40 is applied instead of the boot has a problem in that the gap X is defined between the outer surface of the hard cover 40 and the end of the open upper surface of the console 20 and thus causes irregular manipulation and inflow of foreign materials. Thus, in order to solve this problem, the shift lever assembly according to the present invention includes a gap blocking device for blocking the gap.

The gap blocking device as an exemplary embodiment of the present invention is mounted on the end of the open upper surface of the console 20 such that one end thereof comes into close contact with the outer surface of the hard cover 40, so that a motion path of the hard cover 40 is constantly maintained when the shift lever 10 is manipulated. As a result the shift lever 10 is smoothly manipulated, and noise caused by the gap is prevented. Further, the foreign materials are prevented from being introduced into the console 20 toward the shift lever 10 and the shifter mechanism 50 through the gap, so that durability of the shift lever assembly is improved. In addition, the console 20 is covered such that the interior thereof is not viewed from the outside, so that the beauty of the interior of the vehicle is improved.

The gap blocking device is configured to elastically press the outer surface of the hard cover 40 by means of an elastic force according to an embodiment of the present invention. To this end, as illustrated in FIG. 5, the gap blocking device has the shape of a lip spring 61, whose vertical cross section has a downwardly curved shape, so that it can be mounted in the end of the open upper surface of the console 20. In other words, as illustrated FIG. 5, the downwardly curved part of the lip spring 61 is elastically pressed against the outer surface of the hard cover 40 when the lip spring is mounted, and defines a closed curve along the end of the open upper surface of the console 20. Thereby, the gap can be blocked on an overall region where it can be defined, and the motion path of the hard cover 40 can be more uniformly maintained.

Meanwhile, the gap blocking device is made of metal material, which has a low friction coefficient so as to decrease a frictional force against the hard cover 40 but a high modulus of elasticity so as to increase its elastic force.

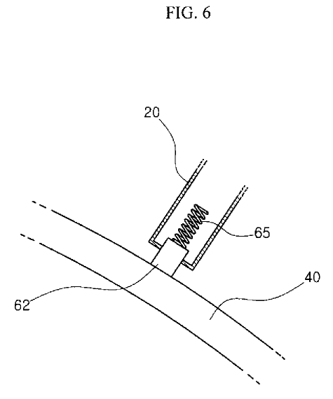

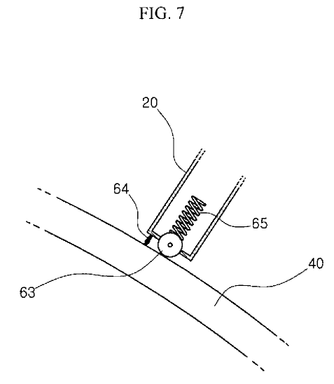

FIGS. 6 and 7 are enlarged cross-sectional views illustrating part “B” of FIG. 4 according to another embodiment of the present invention.

As illustrated in FIG. 6, the gap blocking device according to another embodiment of the present invention includes an annular bar 62 configured to form a closed curve along the end of the open upper surface of the console 20, and at least one elastic spring 65 applying an elastic force to an end portion of the annular bar 62 so as to elastically press one end of the annular bar 62 against the outer surface of the hard cover 40. At this time, preferably, the annular bar 62 can be partly inserted into the end of the open upper surface of the console 20, and the elastic spring 65 can be completely mounted in the other end of the annular bar, that is, in the end of the open upper surface of the console 20.

Further, as illustrated in FIG. 7, the gap blocking device according to another embodiment of the present invention includes a plurality of rollers 63 so as to be able to rotate in close contact with the outer surface of the hard cover 40. In detail, each roller 63 has a cylindrical shape having a predetermined length. These rollers 63 are installed so as to form a closed curve along the end of the open upper surface of the console 20. Each roller 63 is partly inserted into the end of the open upper surface of the console 20, and is closely arranged so as not to be spaced apart from its neighboring roller. At this time, each cylindrical roller 63 is made of soft material, and has a curved shape corresponding to the curvature of the end of the open upper surface of the console 20. With this configuration, the gap is blocked in whole along the end of the open upper surface of the console 20, and the motion path of the hard cover 40 can be uniformly maintained.

Alternatively, each roller 63 may have a spherical shape. Similarly, each roller 63 can be partly inserted into the end of the open upper surface of the console 20, and be arranged so as to minimize a spacing from its neighboring roller.

When these cylindrical or spherical rollers 63 are used as the gap blocking means, there is hardly caused sliding friction between the roller 63 and the hard cover 40, so that the motion path of the hard cover 40 can be uniformly maintained in a more stable way.

As illustrated in FIG. 7, the gap blocking device according to another embodiment of the present invention may further include at least one elastic spring 65, which applies an elastic force to the cylindrical or spherical rollers 63 such that the rollers 63 elastically come into close contact with the outer surface of the hard cover 40. At this time, the spring 65 is mounted in the end of the open upper surface of the console 20. With this configuration, the motion path of the hard cover 40 can be stably guided with stronger elastic force. Further, the gap can be minimized, and the inflow of the foreign materials can be more efficiently prevented.

As described above, in the case in which the rollers 63 are employed as the gap block means, the motion path of the hard cover 40 can be more stably provided. Nevertheless, there is a possibility of forming a fine spacing between the neighboring rollers in view of the shape of the roller 63. As such, the gap blocking device may further include means for preventing inflow of foreign materials, such as a skirt 64, so as to form a closed curve along the end of the open upper surface of the console 20. Further, this skirt 64 can be equally applied to the above-mentioned gap blocking device other than the gap blocking device to which the rollers 63 are applied.

While the present invention has been described with reference to the particular illustrative embodiments and the accompanying drawings, it is not to be limited thereto. Accordingly, the foregoing embodiments can be suitably modified and altered, and such applications fall within the scope and spirit of the present invention that shall be defined by the appended claims.

What is claimed is:

1. A shift lever assembly for a transmission in a vehicle, comprising:
a shift lever;
a shifter mechanism, which is coupled with a lower end of the shift lever and transmits a manipulating force of the shift lever to the transmission;
a hard cover disposed under a console and covering an open upper surface of the console shaped of a hollow semi-sphere, wherein the hard cover is coupled to the shift lever passing through a hollow part of the console and the hard cover; and
gap blocking device being mounted on an end of the open upper surface of the console and configured to block a gap between the end of the open upper surface of the console and an outer surface of the hard cover.

2. The shift lever assembly according to claim 1, wherein the gap blocking device elastically presses the outer surface of the hard cover.

3. The shift lever assembly according to claim 2, wherein the gap blocking device includes at least a lip spring, a vertical cross section of which has a downwardly curved shape so as to form a closed curve along the end of the open upper surface of the console and the outer surface of the hard cover, and is mounted at the end of the open upper surface of the console.

4. The shift lever assembly according to claim 3, wherein the gap blocking device further includes at least a skirt, which is mounted before and behind the lip spring along the end of the open upper surface of the console so as to prevent foreign materials from being introduced through the gap.

5. The shift lever assembly according to claim 2, wherein
the gap blocking device includes at least an annular bar, which is configured to form a closed curve along the end of the open upper surface of the console and the outer surface of the hard cover, and at least one elastic member, which applies an elastic force to the annular bar so as to elastically press the annular bar against the outer surface of the hard cover; and
a portion of the annular bar is partially inserted in the end of the open upper surface of the console and the elastic member is mounted in the end of the open upper surface of the console.

6. The shift lever assembly according to claim 5, wherein the elastic member is an elastic spring.

7. The shift lever assembly according to claim 5, wherein the gap blocking device further includes at least a skirt, which is mounted before and behind the annular bar along the end of the open upper surface of the console so as to prevent foreign materials from being introduced through the gap.

8. The shift lever assembly according to claim 2, wherein the gap blocking device includes a plurality of rollers, which is rotatable in close contact with the outer surface of the hard cover, each roller having a cylindrical shape, is installed along the end of the open upper surface of the console, and is partly inserted into the end of the open upper surface of the console.

9. The shift lever assembly according to claim 8, wherein the gap blocking device further includes at least a skirt, which is mounted before and behind the rollers along the end of the open upper surface of the console so as to prevent foreign materials from being introduced through the gap.

10. The shift lever assembly according to claim 8, wherein the gap blocking device further includes at least one elastic member, which applies an elastic force to the roller such that the rollers are elastically brought into close contact with the outer surface of the hard cover, and is mounted in the end of the open upper surface of the console.

12. The shift lever assembly according to claim 11, wherein the elastic member is an elastic spring.

13. The shift lever assembly according to claim 11, wherein the cylindrical roller is made of soft material.

14. The shift lever assembly according to claim 11, wherein the cylindrical roller has a curved shape corresponding to a curvature of the end of the opening upper surface of the console.

15. The shift lever assembly according to claim 2, wherein the gap blocking device includes a plurality of rollers, which is rotatable in close contact with the outer surface of the hard cover, each roller having a spherical shape, is installed along the end of the open upper surface of the console, and is partly inserted into the end of the open upper surface of the console.

16. The shift lever assembly according to claim 15, wherein the gap blocking device further includes a skirt, which is mounted before and behind the rollers along the end of the open upper surface of the console so as to prevent foreign materials from being introduced through the gap.

17. The shift lever assembly according to claim 16, wherein the gap blocking device further includes at least one elastic member, which applies an elastic force such that the rollers are elastically brought into close contact with the outer surface of the hard cover, and is mounted in the end of the open upper surface of the console.

18. The shift lever assembly according to claim 17, wherein the elastic member is an elastic spring.

19. The shift lever assembly according to claim 17, wherein the cylindrical roller is made of soft material.
